(19) United States
(12) Patent Application Publication
(10) Pub. No.: US 2020/0326178 A1
(43) Pub. Date: Oct. 15, 2020

(54) APPARATUS FOR HOLDING A LASER DISTANCE TOOL FOR DETERMINING THE ELEVATION OF FEATURES OF AN UNDERGROUND STRUCTURE

(71) Applicant: Paul Stephen Schafer, Elkhorn, WI (US)

(72) Inventor: Paul Stephen Schafer, Elkhorn, WI (US)

(73) Assignee: PCS Solutions, LLC., Elkhorn, WI (US)

(21) Appl. No.: 16/383,635

(22) Filed: Apr. 14, 2019

(51) Int. Cl. G01B 11/14; F16B 1/00; F16M 13/02

(52) U.S. Cl. CPC G01B 11/14; F16B 2001/0035; F16M 13/022; F16B 1/00

(57) ABSTRACT

A device for holding a laser measuring device for the vertical measurement of features of a subterranean structure. The device attaches to the opening of the structure by the use of extendable legs and magnets and holds a laser measuring tool with a mounting plate. The plate can slide along the device for the best line of site to the feature being measured.

### SEARCH CLASS

| | |
|---|---|
| U.S. Cl | 33/296; 33/299 |
| Field of Classification Search | 33/281-285; 33/296; 33/299 |

### REFERENCES CITED

U.S. PATENT DOCUMENTS

| | | |
|---|---|---|
| 6,920,394 B2 | July 2005 Johnson | 33/281 |
| 7,441,339 B2 | October 2008 Kallabis | 33/296 |
| 8,230,609 B1 | July 2012 Sanders et al | 33/296 |
| 8,511,635 B2 | August 2013 Steffen | 33/299 |

### BACKGROUND OF THE DISCLOSURE

During the design phase of construction projects, during construction and after projects are complete, it is necessary to obtain the elevations of features inside subsurface structures. Connecting to existing structures is often a part of the design phase and consideration for many underground projects. Accurate recording of these features are either completed during, as a part of the design process for old infrastructure, or after a project has been completed on newer projects which then result in record drawings. These can also be referred to as “as-built” drawings. Due to tight design standards, these elevations and pipe sizes need to be as accurate as possible.

The procurement of “record drawing” measurement can be difficult with current tools. The tools that many use to obtain these measurements in relation to the opening of the structure are graduated survey rods and a straight edge. This method involves placing the survey rod into the pipe which can lead to error if the proper vertical angle is not taken into account and there are sanitary concerns with the placement of the rod into the sewer. In the case of large and shallow structures, the features of the structures cannot be reached with this method which then requires entering of the structure again leading to safety concerns for those taking the measurement and the need for confined space entry. Pipe sizes are often difficult to determine from above ground because one cannot accurately measure them without entering the structure to read the vertical measurement.

The object of this invention is to create a device that can hold several manufacturers' laser measuring tools, properly securing them to the opening of a structure including both pressure and magnets and allowing the device to slide across the opening and swivel in all direction to obtain the best position and location to obtain a line of site on most features of a subterranean structure. This devised used with a laser tool will increase the speed at which the measurements are taken, reduce the need for access into structures and minimize any contamination as no equipment is going into the structure. This devise also allows the user to determine the size of pipes by obtaining accurate elevations on both the bottom and top of the pipe resulting in the determination of size.

This devise has legs that are allowed to extend out from the body of the device making it fully adjustable to any size opening. The legs have locking mechanisms to hold them in place and not allow for movement while the measurements are taken. The device mounting plate has mounting holes as needed to mount multiple manufactures laser equipment and can slide between the leg locking screws. An extension to the mounting plate bracket will lower the laser devise at even foot increments to allow for greater line of site in short and large structures.

According to one illustrative embodiment, there is a survey device for determining an elevation of a subterranean architectural feature. This survey device is not included but the jig will attach to the device of several manufacturers resulting with the same information.

SUMMARY OF THE DISCLOSURE Embodiments of the invention includes a tool to assist with the measurement of features in underground structures by attaching to the opening and holding the laser measurement devise below the jig. This frees up the users hands when working alone, allows for multiple readings from the same locked position reducing the number of tools that were previously needed to obtain the measurements and greatly increases the accuracy due to manually taking the angle of the measurement into account and the deflection of survey rods.

The above and other features of the present disclosure will become apparent from the following description and the attached drawings.

### DESCRIPTION OF THE DRAWINGS

FIG. 1 is a perspective view of the survey device of FIG. 3 elevation view of a survey device which incorporates the features of the present disclosure therein; (this drawing is recommended for the cover sheet)

FIG. 2 is a plan view of the survey device of FIG. 3;

FIG. 3 is a cross section view of FIG. 2 side elevation of the survey device of FIG. 1 positioned over an access portal of a subterranean chamber;

FIG. 4 is a side elevation of FIG. 6 showing the extended legs over the access of large opening subterranean chamber;

FIG. 5 is side elevation showing extension to achieve line of site for large subterranean chambers;

FIG. 6 is a detailed view of the device of FIG. 3 and its components

### DETAILED DESCRIPTION OF AN ILLUSTRATIVE EMBODIMENT

Although the concepts of this disclosure are open to modifications and forms, the detailed description of this disclosure below is not intended to limit modifications but cover the modifications, equivalents and alternatives within the spirit and scope of the disclosure.

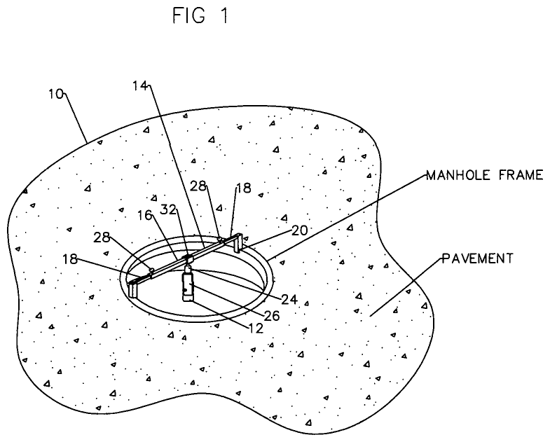

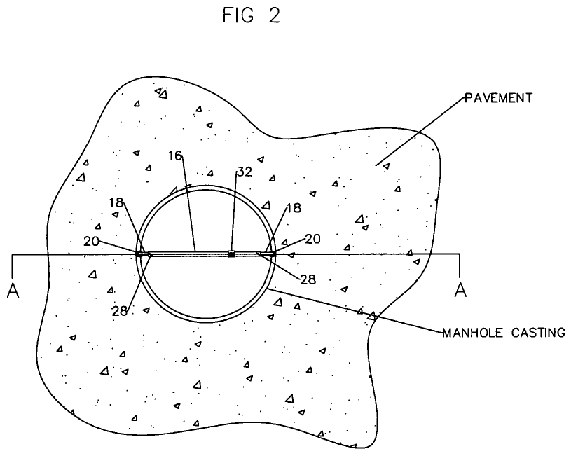

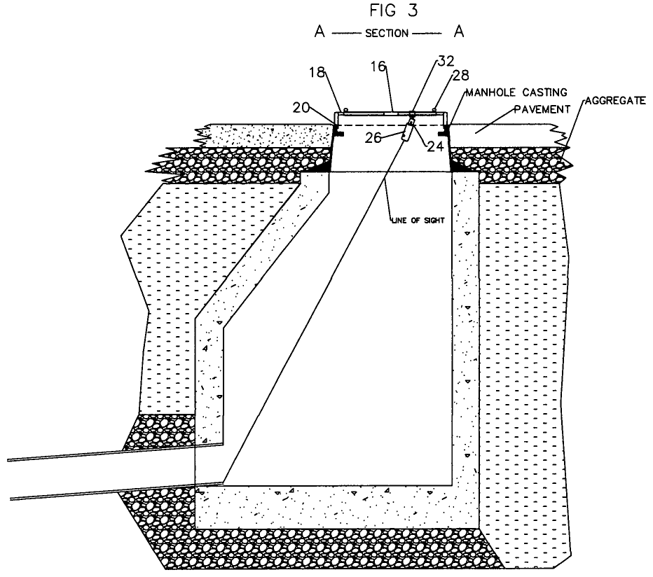

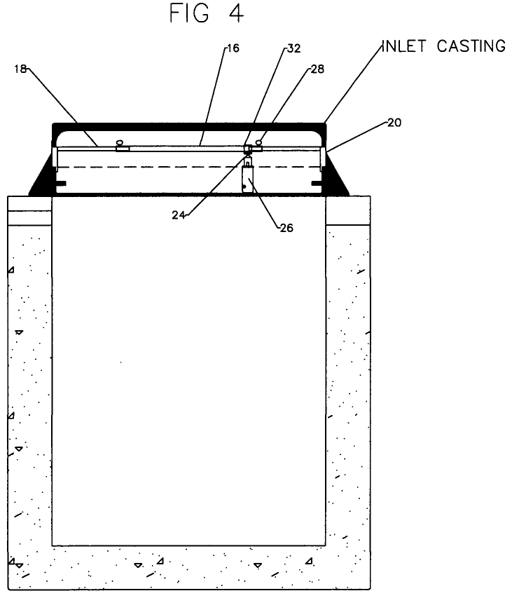

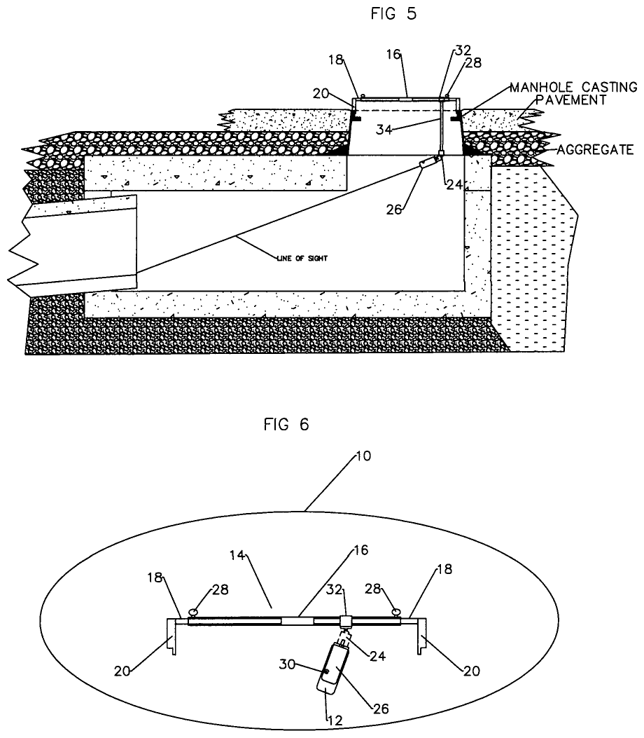

A jig 14 for holding at laser distance measurement tool 12 depicted in FIG. 1 is comprised of main body 16, legs that extend out from the main body 18, devices to lock the legs in place 28, feet with magnetized bases 20, a sliding coupler 32, an articulating joint 24 and laser mounting plate 26. The mounting plate 26 in FIG. 6 will have multiple mounting locations 30 to allow for many different mounting tools. The option of an extension 34 from FIG. 5

All pieces are made from aluminum square tube, bar or plate but this concept does not limit it to the material or structure shape and can be steel, aluminum, plastic, carbon fiber, polyethylene and can be round, rectangle, tube or channel. This jig shows the concept of holding a laser measuring tool from a variety of manufactures and anchors to the edge of the structure opening allowing for the measurement of features from the inside of the structure opening and allows for the flexibility to move the measurement device around the opening and articulates to measure features 180 degrees around the structure without having to adjust the mounting of the jig.

The legs 18 slide in and out of the main body 16 and are locked in place by the use of a threaded mechanism pushing against the leg inside the body allowing for the feet 20 to be securely siting on the frame of the structure. The legs 18 and feet 20 are sized to fit standard utility manhole and catch basin/inlet structures but the legs 18 can be made longer to fit a variety of openings such as a vault.

The mounting plate 26 shown in FIG. 6 is attached to the articulating joint 24 with a threaded connection and epoxy or welded connection. The articulating joint 24 is attached to the sliding coupler 32 using a threaded and epoxy or welded connection.

While the disclosure has been illustrated detail in the drawings and previous description, such an illustration and description is to be considered as exemplary and not restrictive in character, it being understood that only illustrative embodiments have been shown and described and that all changes and modifications that come within the spirit of the disclosure are desired to be protected.

There are many advantages of the present disclosure arising from the various features of the apparatus, methods, systems, and programs described herein.

What is claimed is:

1. A jig to be used to hold a laser distance measuring tool over an opening which allows for the measurement of features inside the structure. A jig for determining an elevation of a subterranean architectural feature located in a subterranean chamber, the survey device comprising of:
a. A body
b. Extending Legs
c. Magnetic feet
d. Articulating mounting plate

2. A jig with adjustable legs extending out from a main body. These legs can be made of different shape tube or bar including square and round.

3. A jig according to claim 2 with locking mechanism to secure the legs in place from extending out or retracting into the body of the jig.

4. A jig with magnetized feet extending on the end of each leg according to claim 2. These feet rest on the structure opening and secure to ferrous materials.

5. A jig with articulating joint attached to the main body allowing for the best angle so see structure features.

6. A jig according to claim 5 where the joint is attached to the main body with a coupler allowing the joint to slide from end to end of the main body.

7. A jig with a bracket designed to allow for any measuring device to be attached to it using multiple mounting hole locations. This bracket is attached to the main body through the articulating joint from claim 5.

8. A jig with a bar or tube of a predetermined length allowing for the bracket in claim 7 and joint in claim 5 to attach to the main body in claim 1 and hang lower in the structure to obtain a line of site to features in short or large structures.
